(19) United States
(12) Patent Application Publication
(10) Pub. No.: US 2007/0061323 A1
(43) Pub. Date: Mar. 15, 2007

(54) Apparatus and method for displaying data, and program thereof

(75) Inventors: Masaki Murata, Tokyo (JP); Koji Ichii, Hiroshima (JP); Qing Ma, Tokyo (JP); Tamotsu Shirado, Tokyo (JP); Hitoshi Isahara, Tokyo (JP)

Correspondence Address: STAAS & HALSEY LLP, SUITE 700, 1201 NEW YORK AVENUE, N.W., WASHINGTON, DC, 20005, US

(73) Assignee: National Institute of Information and Communications Technology, Tokyo (JP)

(21) Appl. No.: 11/373,487

(22) Filed: Mar. 13, 2006

(30) Foreign Application Priority Data
Sep. 14, 2005 (JP) 2005-266410

(51) Int. Cl. G06F 17/30

(52) U.S. Cl. 707/7

(57) ABSTRACT

A reference value calculation unit calculates, as a reference value, the value in which the mean value, the mode value and the median are averaged by obtaining the mean value, the mode value and the median for the year at which the document containing each keyword is published, based on the annual publication data inputted into a data input unit. A data sort unit sorts the annual publication data for each keyword, based on the calculated reference value. And a data display unit creates a display data based on the sorted annual publication data and displays the created display data on a screen.

### CROSS-REFERENCE TO RELATED APPLICATIONS

This application claims the conventional priority based on Japanese patent application serial No. 2005-266410, filed on Sep. 14, 2005, the disclosures of which are incorporated herein by reference.

### BACKGROUND OF THE INVENTION

1. Field of the Invention

The present invention generally relates to a data display technique, and particularly to an apparatus and method for displaying data, and a data display program for displaying the data corresponding to the ordered item (for example, year). More particularly, the invention displays the transition in the number of cases released of the document data for every keyword contained in the released document data.

2. Description of the Related Art

Each research institute for university or enterprise publishes useful researches every year in the annual meeting or treatises. FIG. 21 shows the transition in the number of cases released in the treatises or annual meeting. The number of cases released is significantly larger in the annual meeting than the treatises. Also, the number of cases temporarily decreases in both (in the eighth year for the treatises or the sixth year for the annual meeting), but tends to increase on the whole.

The annual meeting and the treatises have a temporary peak in the fourth and sixth years, and temporarily fall in the sixth and eighth years respectively. Just two years after the year when the peak and the fall occur in the annual meeting, the peak and the fall occur in the treatises. This may be caused because the treatises take a lot of time to perform the contribution, reading and printing, whereby the research is published in the treatises later than the annual meeting even when the research is made in the same period.

The data (annual publication data) of the number of cases released in each year for each research institute can be displayed in a table format, employing a technique for displaying the inputted data in the table format as described in a non-patent document (refer to Operation handbook, Standard Excel, Bible for all functions, 2003, Yoshinori Murata, Gijutsu Hyoron-Sha, 2004.2.1 published).

Conventionally, there is provided a technique for manually sorting the annual publication data of the document containing a certain keyword (for example, research institute name, research field name) in the order of keywords in which the number of cases released is larger, for example.

However, with the conventional technique, it is difficult to automatically display the transition in the number of cases released for every keyword to grasp it at a glance. For example, if the research institute is adopted as the keyword, it is not possible to automatically display visually the transition in the number of cases released for each research institute to grasp at a glance a trend in the number of cases released, such as a tendency in which the number of cases released recently increases or decreases in the research institute.

Also, for example, if the research field is adopted as the keyword, it is not possible with the conventional technique to display the number of cases released recently tending to increase or decrease in the research field to grasp it at a glance.

### SUMMARY OF THE INVENTION

It is an object of the present invention to provide an apparatus for displaying data for automatically displaying the data (for example, numerical data) corresponding to an ordered item (for example, annual) related to a description data (for example, document) containing a data item (for example, keyword). It is another object of the present invention to provide a method for displaying data for automatically displaying the data (for example, numerical data) corresponding to an ordered item (for example, annual) related to a description data (for example, document) containing a data item (for example, keyword). It is still another object of the present invention to provide data display program for displaying data for automatically displaying the data (for example, numerical data) corresponding to an ordered item (for example, annual) related to a description data (for example, document) containing a data item (for example, keyword). More particularly, it is an object of the invention to automatically display a transition in the number of cases released for every keyword in a format where a trend in the number of cases released of the document for every keyword can be grasped at a glance.

The apparatus for displaying data of the present invention displays data corresponding to an ordered item. The apparatus comprises a data input unit inputting the data corresponding to the ordered item related to a description data containing a data item, a reference value calculation unit calculating, for each of the data item, a reference value that is referenced in sorting the inputted data related to the description data containing each of the data item, based on the inputted data related to the description data containing each of the data item, a data sort unit sorting the data related to the description data containing each of the data item in the ascending or descending order of the calculated reference values, and a data display unit creating a display data based on the sorted data and displaying the created display data on a screen.

Preferably, the apparatus for displaying data of the present invention displays numerical data corresponding to an ordered item. The apparatus comprises a data input unit inputting the numerical data corresponding to the ordered item related to a description data containing a data item, a reference value calculation unit calculating, for each of the data item, a reference value that is referenced in sorting the numerical data, based on the input numerical data, a data sort unit sorting the numerical data related to the description data containing each of the data item in the ascending or descending order of the calculated reference values, and a data display unit creating a display data based on the sorted numerical data and displaying the created display data on a screen.

Preferably, in the apparatus of the present invention, the reference value calculation unit calculates the reference value, based on the order value of the ordered item.

Preferably, in the apparatus of the present invention, the reference value calculation unit calculates the reference value in which the mean value, the mode value and the median of the order values of the ordered items are averaged.

Preferably, in the apparatus of the present invention, the reference value calculation unit calculates, as the reference value, the mean value of the order values of the ordered items.

Preferably, in the apparatus of the present invention, the reference value calculation unit calculates, as the reference value, the mode value of the order values of the ordered items.

Preferably, in the apparatus of the present invention, the reference value calculation unit calculates, as the reference value, the median of the order values of the ordered items.

Preferably, in the apparatus of the present invention, the data display unit displays the data in which the reference value calculated for each of the data item is plotted as a part of the display data on the screen.

Preferably, in the apparatus of the present invention, the data display unit further displays the display data on the screen in a format where the reference value calculated for each of the data item is written down with the display data.

Preferably, in the apparatus of the present invention, the data input unit comprises a data accumulation unit accumulating an inputted bibliography data, a data item extraction unit extracting a data item from the accumulated bibliography data, and a data creation unit creating the data corresponding to the ordered item related to the description data containing each of the data item, based on the extracted data item and the bibliography data, and the reference value calculation unit calculates, for each of the data item, the reference value that is referenced in sorting the data related to the description data containing each of the data item, based on the created data related to the description data containing each of the data item.

The method for displaying data of the present invention displays data corresponding to an ordered item. The method comprises inputting the data corresponding to the ordered item related to the description data containing a data item, calculating, for each of the data item, a reference value that is referenced in sorting the inputted data related to the description data containing each of the data item, based on the inputted data related to the description data containing each of the data item, sorting the data related to the description data containing each of the data item in the ascending or descending order of the calculated reference values, creating a display data based on the sorted data, and displaying the created display data on a screen.

The program for displaying data of the present invention displays data corresponding to an ordered item. The program causes a computer to execute inputting the data corresponding to the ordered item related to a description data containing a data item, calculating, for each of the data item, a reference value that is referenced in sorting the inputted data related to the description data containing each of the data item, based on the inputted data related to the description data containing each of the data item, sorting the data related to the description data containing each of the data item in the ascending or descending order of the calculated reference values, creating a display data based on the sorted data, and displaying the created display data on a screen.

The apparatus, method, and program of the present invention automatically sort the data (for example, numerical data) corresponding to the ordered item (for example, year) related to the description data (for example, document) containing each keyword based on the reference value and display the sorted data on the screen.

More specifically, the apparatus, method, and program of the present invention automatically sort the data (annual publication data) of the number of cases released in each year for the document containing individual keywords based on the reference value and display the transition in the number of cases released for a plurality of keywords after sorting. Therefore, it is possible to grasp a trend in the number of cases released for each keyword at a glance.

### BRIEF DESCRIPTION OF THE DRAWINGS

FIG. 1 is a diagram showing one example of a structure of an apparatus for displaying data according to the present invention.

FIG. 2A and FIG. 2B are diagrams showing one example of data inputted into a data input unit.

FIG. 3 is a flowchart showing one example of a data display process according to a first embodiment of the invention.

FIG. 4 is a screen display example of the display data.

FIG. 5 is a screen display example of the display data.

FIG. 6 is a screen display example of the display data.

FIG. 7A to FIG. 7C are screen display examples of the display data.

FIG. 8 is a screen display example of the display data.

FIG. 9 is a screen display example of the display data.

FIG. 10 is a screen display example of the display data.

FIG. 11 is a screen display example of the display data.

FIG. 12 is a screen display example of the display data.

FIG. 13 is a screen display example of the display data.

FIG. 14 is a flowchart showing one example of a data display process according to a second embodiment of the invention.

FIG. 15 is a view showing one example of the bibliography data.

FIG. 16 is a screen display example of the display data.

FIG. 17 is a screen display example of the display data.

FIG. 18 is a screen display example of the display data.

FIG. 19 is a screen display example of the display data.

FIG. 20 is a screen display example of the display data.

FIG. 21 is a view showing a transition example of the number of cases released in the treatises and the annual meeting.

### DETAILED DESCRIPTION OF THE PREFERRED EMBODIMENTS

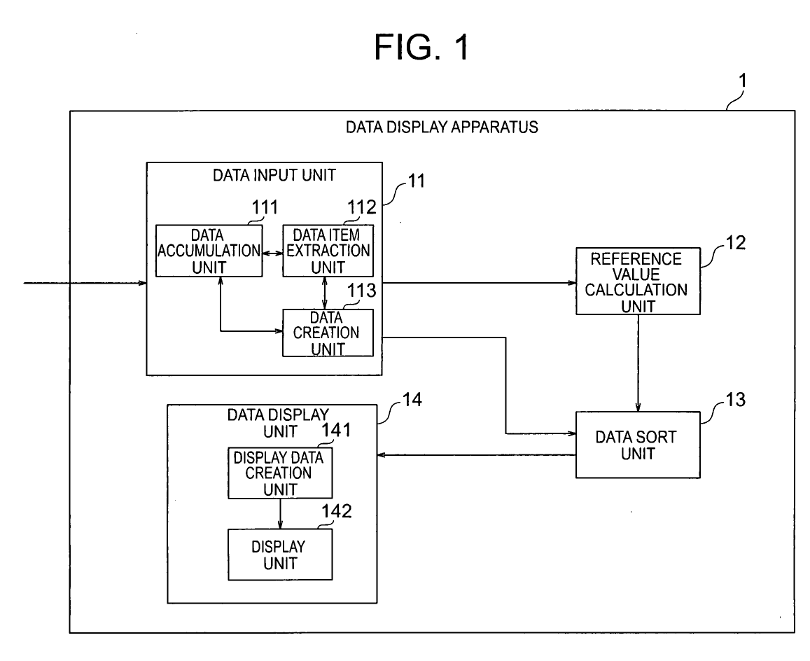

FIG. 1 is a diagram showing one example of a structure of an apparatus for displaying data according to the present invention. The data display apparatus 1 displays a data (for example, numerical data) corresponding to an ordered item related to a description data (for example, document) containing a data item (for example, keyword) on a screen. For example, it displays an annual publication data for the keyword such as a research institute or a research field on the screen. The data display apparatus 1 includes a data input unit 11, a reference value calculation unit 12, a data sort unit 13, and a data display unit 14.

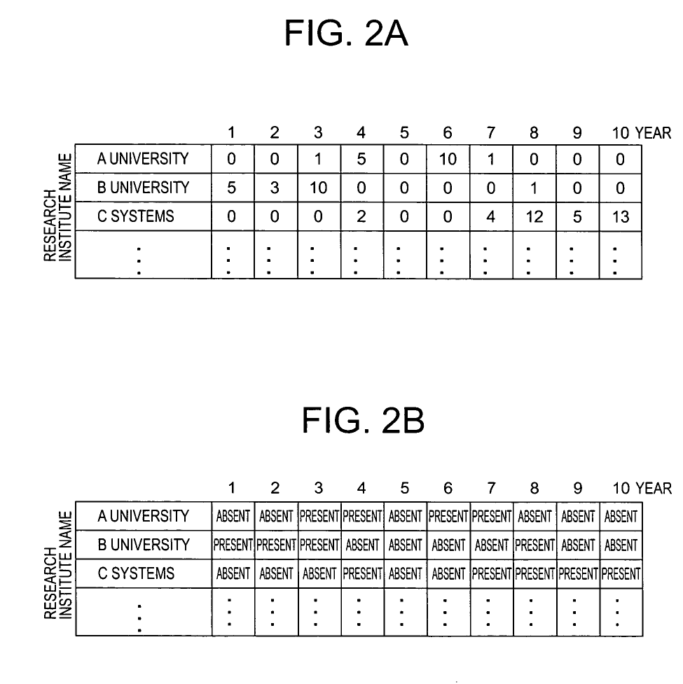

The data input unit 11 inputs a data (for example, numerical data) corresponding to an ordered item related to a description data (for example, document) containing a data item (for example, keyword). The data input unit 11 inputs, for example, an annual publication data as shown in FIG. 2A. In the annual publication data as shown in FIG. 2A, for A university as one keyword, the number of document publications is one in the third year, five in the fourth year, ten in the sixth year, and one in the seventh year, and for B university, the number of document publications is five in the first year, three in the second year, ten in the third year, and one in the eighth year, and for C systems, the number of document publications is two in the fourth year, four in the seventh year, twelve in the eighth year, five in the ninth year, and thirteen in the tenth year.

Also, the data input unit 11 inputs, for example, the data as shown in FIG. 2B. The data as shown in FIG. 2B indicates, for example, the presence or absence of document publication in each year of each research institute, in which there is document publication in the year where data “present” is stored and there is no document publication in the year where data “absent” is stored.

In the embodiment of the present invention, the data input unit 11 may input a bibliography data, create a data (for example, data of the number of cases released in each year for the document containing individual keywords (annual publication data)) corresponding to the ordered item related to the description data (example, document) containing a data item (for example, keyword), based on the input bibliography data, and output the created data.

The reference value calculation unit 12 calculates, for each of the data item, the reference value that is referenced in sorting the output data based on the data corresponding to the ordered item related to the description data (for example, document) containing each of the data item, which is outputted from the data input unit 11. A calculation example of the reference value will be described later.

The data sort unit 13 sorts the data corresponding to the ordered item related to the description data (for example, document) containing each of the data item, based on the reference value calculated by the reference value calculation unit 12. The data sort unit 13 sorts the data (for example, annual publication data) corresponding to the ordered item for each of the data item in the ascending or descending order of the reference values.

The data display unit 14 displays the display data by creating the data (display data) to be displayed based on the data sorted by the data sort unit 13.

The data input unit 11 may include data accumulation unit 111, data item extraction unit 112, and data creation unit 113, for example, as shown in FIG. 1. The data accumulation unit 111 accumulates the inputted bibliography data. The data item extraction unit 112 extracts the data item (for example, keyword) from the accumulated bibliography data. The data creation unit 113 creates the data corresponding to the ordered item related to the description data (for example, document) containing each of the data item, based on the bibliography data and the extracted data item. For example, it creates and outputs the annual publication data, for example, as shown in FIG. 2A.

In this embodiment of the invention, the data input unit 11 may not include the data item extraction unit 112 and the data creation unit 113, but may output the data (for example, annual publication data) corresponding to the ordered item related to the description data (for example, document) containing a data item (for example, keyword), which is inputted into the data accumulation unit 111.

The data display unit 14 includes display data creation unit 141 and display unit 142. The display data creation unit 141 creates a display data to be displayed, based on the data (for example, annual publication data) corresponding to the ordered item for each of the data items sorted by the data sort unit 13. The display unit 142 displays the display data created by the display data creation unit 141 on the screen.

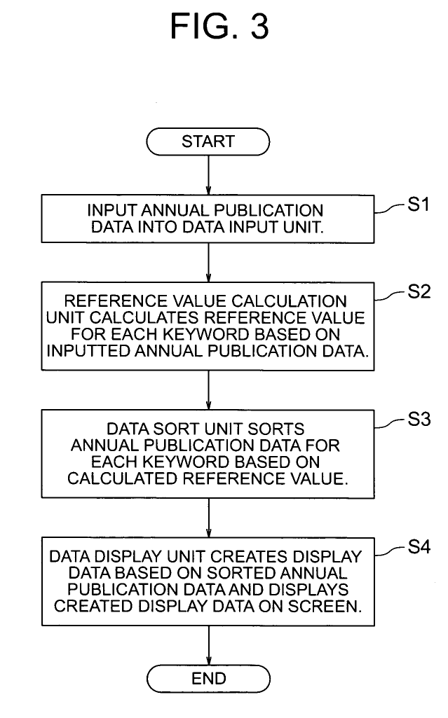

FIG. 3 is a flowchart showing one example of the data display process according to the first embodiment of the invention. In the processing flow of FIG. 3, the data input unit 11 inputs the annual publication data for each keyword as the data corresponding to the ordered item related to the description data containing each of a data item.

First of all, an annual publication data is inputted into the data input unit 11 (step S1). For example, the annual publication data for each keyword (each research institute in FIG. 2A) as shown in FIG. 2A is inputted.

Next, the reference value calculation unit 12 calculates a reference value for each keyword, based on the inputted annual publication data (step S2). For example, the mean value, the mode value and the median for the years of publication are obtained, and the mean value of them is calculated as the reference value. Herein, the mean value for the years of publication is the total value of the year of publication multiplied by the number of cases released, divided by the total number of cases released. For example, for A university in FIG. 2A, since the number of publishing the document is one in the third year, five in the fourth year, ten in the sixth year, and one in the seventh year, the mean value for the years of publication is equal to (3×1+4×5+6×10+7×1)/17=5.29.

Also, the mode value for the years of publication is the value of year in which the number of cases released is largest. For example, for A university, the mode value is the value “6” of the year (sixth year) in which the number of cases released is largest, “10”. Also, the median for the years of publication is the value of year to which the middle data belongs in the data of the number of cases released. For example, for A university, the median is the value “6” of the year (sixth year) to which the ninth data as the middle data belongs in the data of the number of cases released from 1 to 17.

Accordingly, the reference value for A university is calculated as (5.29+6+6)/3=5.76.

Of course, in the embodiment of the present invention, a calculation method for the reference value is not limited to the above described method, but the calculated mean value, mode value or median for the years of publication may be directly employed as the reference value, or the mean value, mode value and median for the years of publication may be appropriately combined to calculate the reference value based on a predetermined calculation method.

In the embodiment of the present invention, the data corresponding to the ordered item (for example, year) inputted into the data input unit 11 is not limited to the numerical data, but the inputted data may be a language representation, for example. That is, when the data as shown in FIG. 2B, instead of the annual publication data as shown in FIG. 2A, is inputted into the data input unit 11 at step S1, the reference value is calculated in the following manner at step S2. That is, in FIG. 2B, for the year in which the language representation “present” is stored, the number of cases released is “1”, while for the year in which the language representation “absent” is stored, the number of cases released is “0”, whereby the mean value, the mode value and the median for the years of publication are obtained, and the mean value of them is calculated as the reference value.

Of course, in the embodiment of the present invention, the reference value may be calculated by converting each language representation inputted as the data corresponding to the ordered item (for example, year) into the predetermined numerical value associated with each language representation, and employing the numerical value after conversion.

Next, the data sort unit 13 sorts the annual publication data for each keyword, based on the calculated reference value (step S3). For example, the data sort unit 13 sorts the annual publication data for each keyword in the ascending order of the reference values. The data sort unit 13 may sort the annual publication data for each keyword in the descending order, based on the calculated reference value.

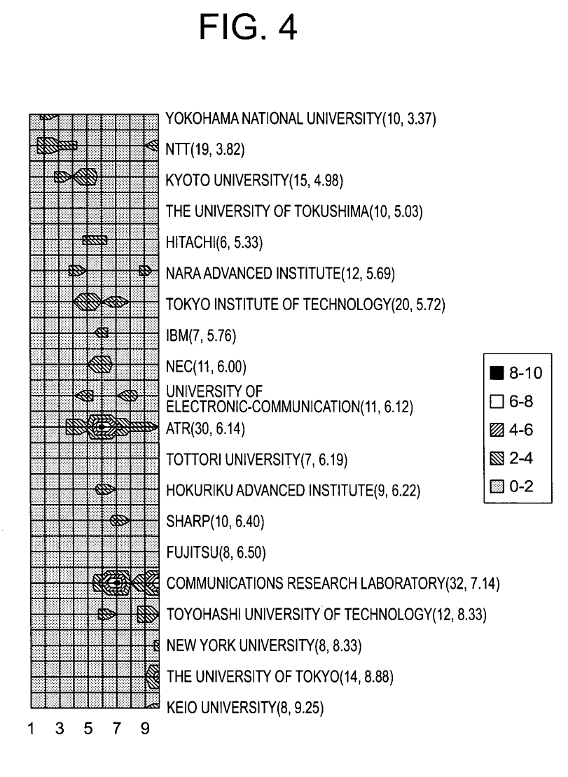

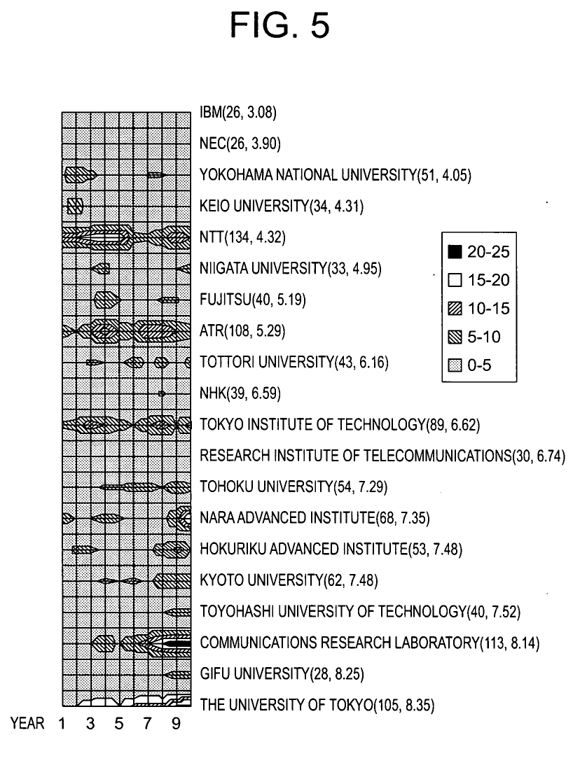

Next, the data display unit 14 creates a display data based on the sorted annual publication data and displays the created display data on a screen (step S4). The data display unit 14 converts the data of the number of cases released in each year for each research institute into contour line data, and displays a screen where the data of the number of cases released in the treatises in each year for each research institute is represented with the contour line, as shown in FIG. 4. The display color of the contour line is different depending on the degree of the number of cases released. Also, the data display unit 14 displays the data of the number of cases released at the annual meeting in each year for each research institute with the contour line, as shown in FIG. 5.

In a screen display example as shown in FIG. 4, the research institute that publishes more literatures in earlier years is displayed at the upper level. Also, in the embodiment of the present invention, the data display unit 14 may display the display data on the screen in the format where the total number of cases released and the reference value are written down with the annual publication data for each keyword, as shown in FIG. 4. For example, for Yokohama National University of FIG. 4, a description (10, 3.37) indicating that the number of cases released is 10 and the reference value is 3.37 is written down along with the research institute name “Yokohama National University”.

As seen from FIG. 4, for example, the number of cases released in the treatises is larger in ATR and Communications Research Laboratory. Also, as seen from FIG. 5, the number of cases released in the annual meeting is larger in NTT, ATR, Tokyo Institute of Technology, Communications Research Laboratory and The University of Tokyo. Though NTT and ATR make many publications from the earlier years, Communications Research Laboratory and The University of Tokyo make many publications in relatively later years among ten years. Also, Communications Research Laboratory and The University of Tokyo have a tendency that the number of cases released is increasing, and it is foreseen that the number of cases released will increase in the future. It can be easily known in which year other organizations make many publications by referring to FIGS. 4 and 5.

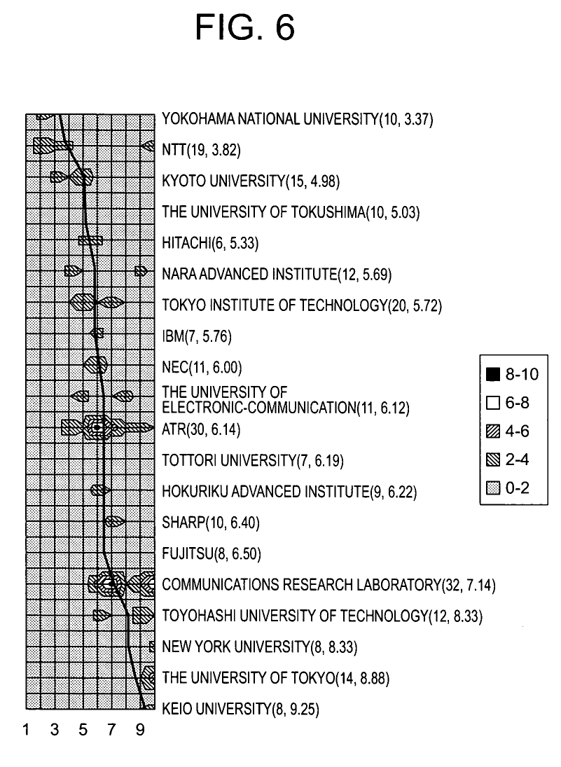

In the embodiment of the present invention, at step S4, the data display unit 14 may convert the data of the number of cases released in each year for each keyword into contour line data, create the kinked line data in which the reference value is plotted for each keyword, and display the contour line data of the number of cases released in each year for each keyword and the kinked line data of the reference value for each keyword as indicated by the bold kinked line on the same screen, as shown in FIG. 6.

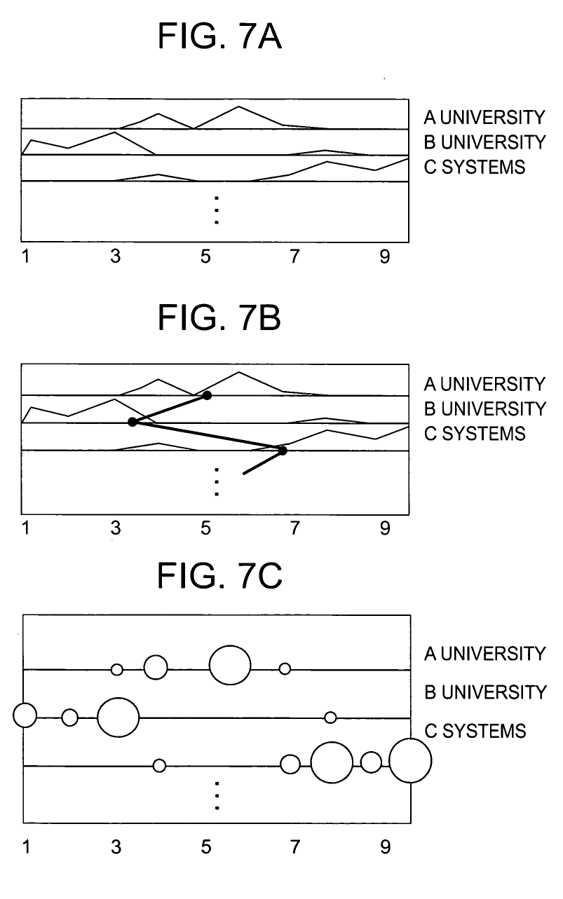

Also, in the embodiment of the invention, at step S4, the data display unit 14 may convert the data of the number of cases released in each year for each keyword into the kinked line data, and display a screen in which data of the number of cases released in each year for each keyword is represented as the kinked line, as shown in FIG. 7A. Of course, in the embodiment of the invention, the kinked line data of the number of cases released in each year for each keyword and the kinked line data of the reference value for each keyword as indicated by the bold kinked line may be displayed on the same screen, as shown in FIG. 7B.

Also, in the embodiment of the present invention, at step S4, the data display unit 14 may display the data of the number of cases released in each year for each keyword as a bubble chart on the screen, as shown in FIG. 7C. The bubble chart commonly means a view in which a circle (bubble) representing a certain event is arranged on the chart having two axes. In the bubble chart as shown in FIG. 7C, the size of circle indicates the degree of the number of cases released. Of course, in the embodiment of the invention, on the bubble chart, the kinked line data of the reference value for each keyword may be displayed along with the data of the number of cases released in each year for each keyword on the screen.

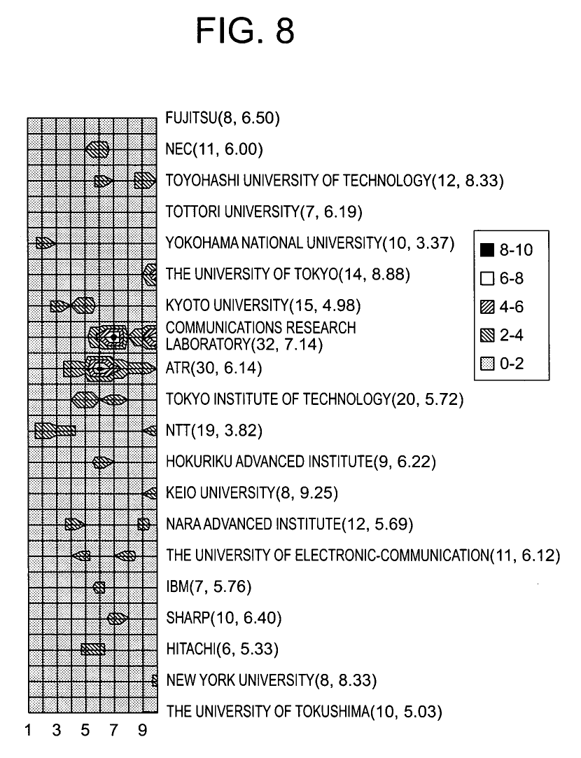

In the following, various screen display examples of display data will be described below. FIG. 8 is a view showing a screen display example of display data when the annual publication data in the treatises are rearranged randomly by generating the random number. In the screen display example as shown in FIG. 8, it is difficult to grasp at a glance which research institute publishes the documents in earlier years, or which research institute publishes the documents in later years.

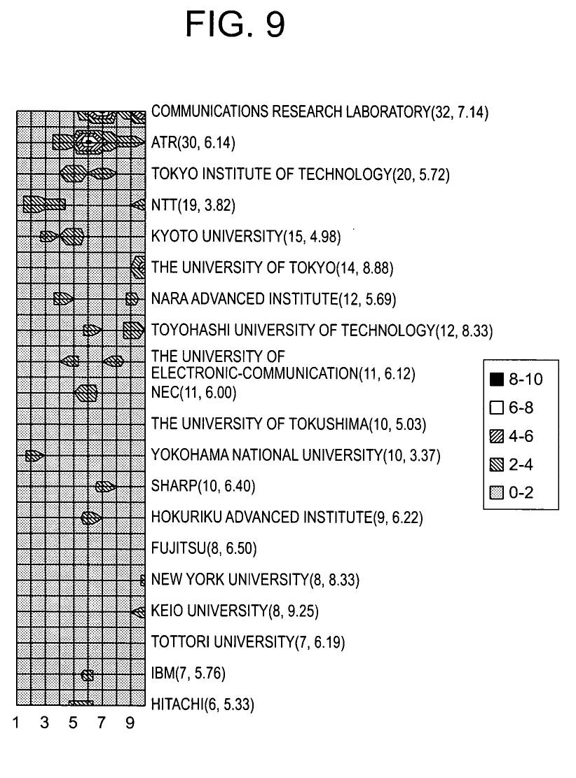

FIG. 9 is a view showing a screen display example of display data when the annual publication data for the treatises are sorted in the descending order of the number of cases released. In the screen display example as shown in FIG. 9, it is convenient to consider which research institute publishes more documents, but it is difficult to grasp which research institute publishes the documents in earlier years, or which research institute publishes the documents in later years.

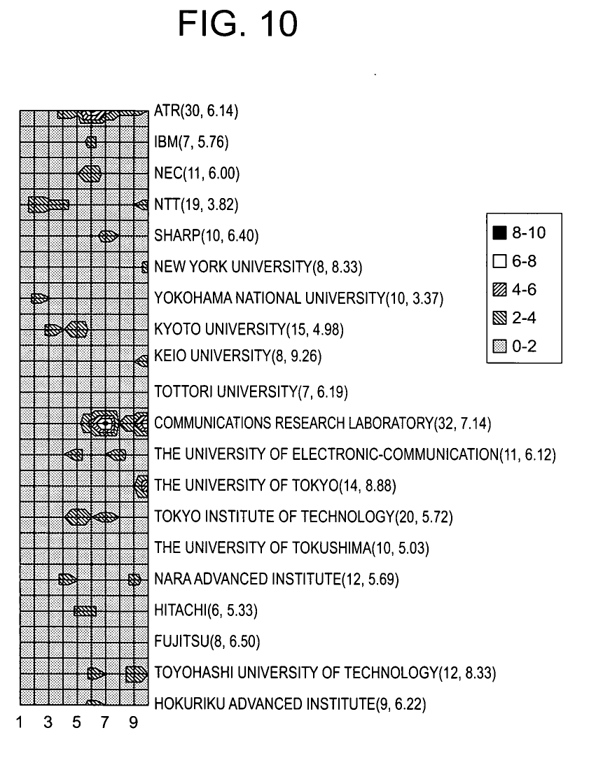

FIG. 10 is a view showing a screen display example of display data when the annual publication data in the treatises are sorted in the order of the EUC codes of research institute names. In the screen display example as shown in FIG. 10, firstly the research institute names in half angle characters, secondly the research institute names in katakana characters, and then the research institute names in Chinese character are displayed from the top. The research institute names in half angle characters and the research institute names in Chinese character are displayed in the order of the EUC codes. The screen display example as shown in FIG. 10 is helpful to consider in which year the number of cases releases is large for a specific research institute, but is hard to see for other consideration.

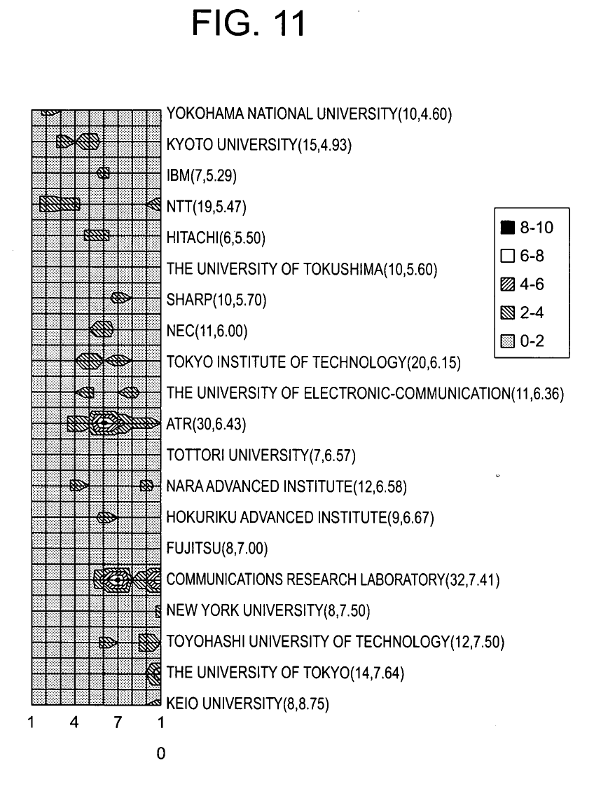

FIG. 11 is a view showing a screen display example of display data when the annual publication data for the treatises are sorted based on the mean value for the years of publication. In FIG. 11, a description indicating the total number of cases released and the mean value for the years of publication is written down with each research institute name. For example, for Yokohama National University, the total number of cases released is 10 and the mean value for the years of publication is 4.60. The screen display example as shown in FIG. 11 is convenient to consider which research institute publishes many documents in the earlier years.

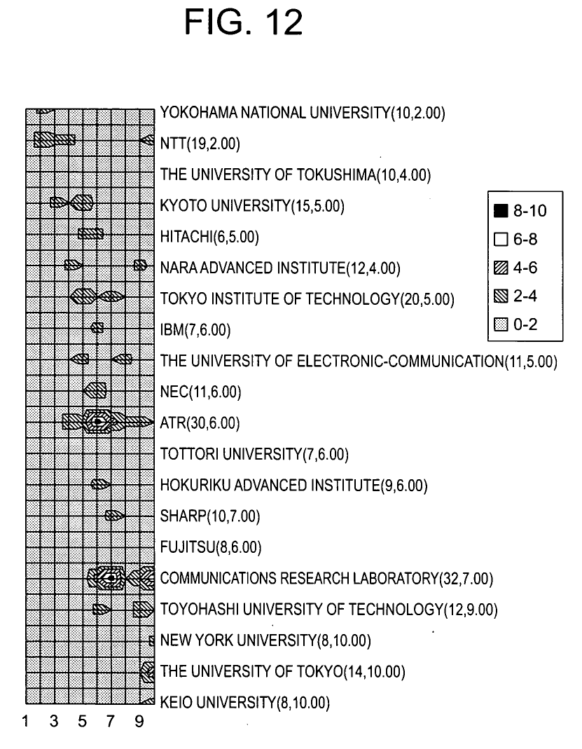

FIG. 12 is a view showing a screen display example of display data when the annual publication data for the treatises are sorted based on the mode value for the years of publication. In FIG. 12, a description indicating the total number of cases released and the mode value for the years of publication is written down with each research institute name. For example, for Yokohama National University, the total number of cases released is 10 and the mode value for the years of publication is 2.00. The screen display example as shown in FIG. 12 is convenient to consider which research institute publishes many documents in the earlier years.

The screen display example as shown in FIG. 12 looks fine because the data are arranged in the ascending order of the values for the years having the highest contour line for each research institute. However, as will be apparent from the mode value for the years of publication for each research institute, a lot of research institutes have the same score. Accordingly, the research institutes having the same score may be arranged in any order. Hence, to avoid the same score, the mode value for the years of publication is not simply employed, but the annual publication data may be rearranged and displayed in terms of the reference value calculated based on the mode value, the mean value and the median, as in the screen display example of FIG. 4.

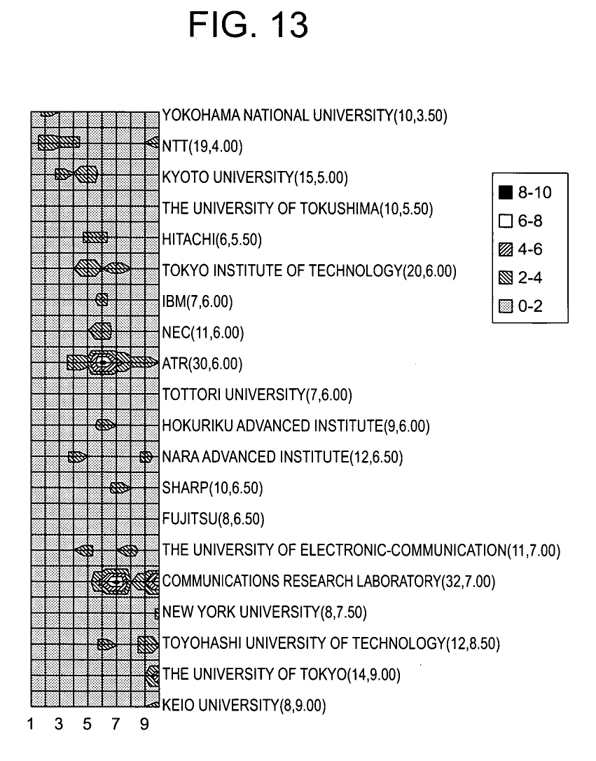

FIG. 13 is a view showing a screen display example of display data when the annual publication data for the treatises are sorted based on the median for the years of publication. In FIG. 13, a description indicating the total number of cases released and the median for the years of publication is written down with each research institute name. For example, for Yokohama National University, the total number of cases released is 10 and the median for the years of publication is 3.50. The screen display example as shown in FIG. 13 is convenient to consider which research institute publishes many documents in the earlier years.

However, as will be apparent from the median for the years of publication for each research institute, a lot of research institutes have the same score. Accordingly, the research institutes having the same score may be arranged in any order. Hence, to avoid the same score, the median for the years of publication is not simply employed, but the annual publication data may be rearranged and displayed in terms of the reference value calculated based on the mode value, the mean value and the median, as in the screen display example of FIG. 4.

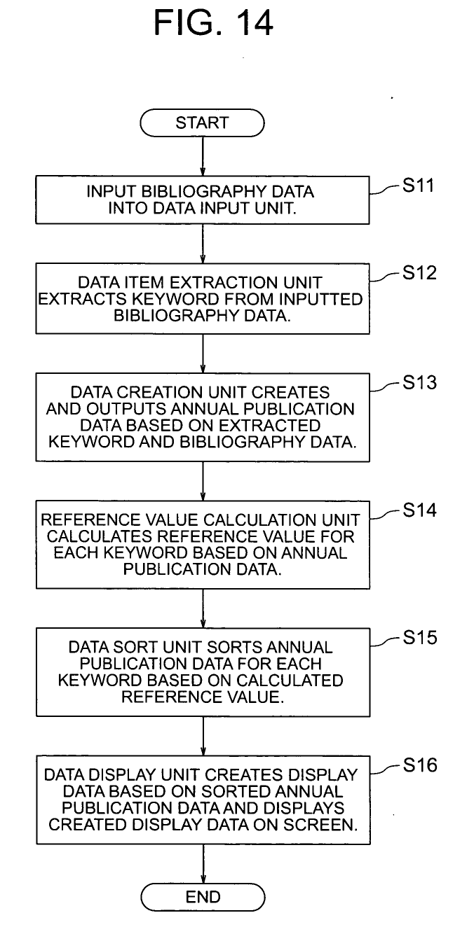

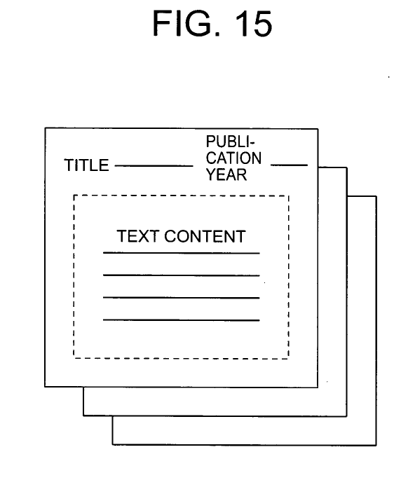

FIG. 14 is a flowchart showing one example of a data display process according to a second embodiment of the invention. In the second embodiment, the data input unit 11 creates and outputs the annual publication data as the numerical data based on an inputted bibliography data including a title of published document, text content of document, and a data such as years of publication shown in FIG. 15.

First of all, the bibliography data is inputted into the data input unit 11 (step S11). For example, the bibliography data as shown in FIG. 15 is inputted. Then, the data item extraction unit 112 extracts a keyword from the inputted bibliography data (step S12).

To extract the keyword, a well-known morpheme analysis tool, a Chasen, is employed. Employing the Chasen, a Japanese sentence is decomposed, and the part of speech for each word is estimated. A division example of a Japanese sentence using Chasen will be described.

For example, if [symbol] (Gakko he iku)” is inputted, the following results are obtained.

[symbol] (gakko) [symbol] (gakko) [symbol] (gakko) Noun in general [symbol] (he) [symbol] (he) [symbol] (he) particle—case particle in general [symbol] (iku) [symbol] (iku) [symbol] (iku) verb—independent [symbol] (godan kagyo) long consonant fundamental form

EOS

The sentence is decomposed with one word in each line, and the information of reading and part of speech is appended to each word.

As a part of speech tagging system for English, Brill (Transformation-Based Error-Driven Learning and Natural Language Processing: A Case Study in Part-of-Speech Tagging, Computational Linguistics, Vol. 21, No. 4, p. 543-565, 1995) is famous, in which the part of speech of each word in the English sentence can be estimated.

In the embodiment of the invention, each morpheme obtained by decomposing the title by Chasen is extracted as the keyword.

For example, each morpheme obtained by decomposing the tile by Chasen, in which the number of morpheme appearing in the bibliography data is greater than or equal to a threshold, may be extracted as the keyword in the embodiment of the invention.

Next, the data creation unit 113 creates and outputs the annual publication data based on the extracted keyword and bibliography data (step S13). At step S13, the data of the number of cases released in each year for the document containing the keyword extracted at step S12 in the title is created as the annual publication data for the keyword, for example.

Next, the reference value calculation unit 12 calculates the reference value for each keyword, based on the annual publication data (step S14). And the data sort unit 13 sorts the annual publication data for each keyword, based on the calculated reference value (step S15).

And the data display unit 14 creates a display data based on the sorted annual publication data and displays the created display data on a screen (step S16).

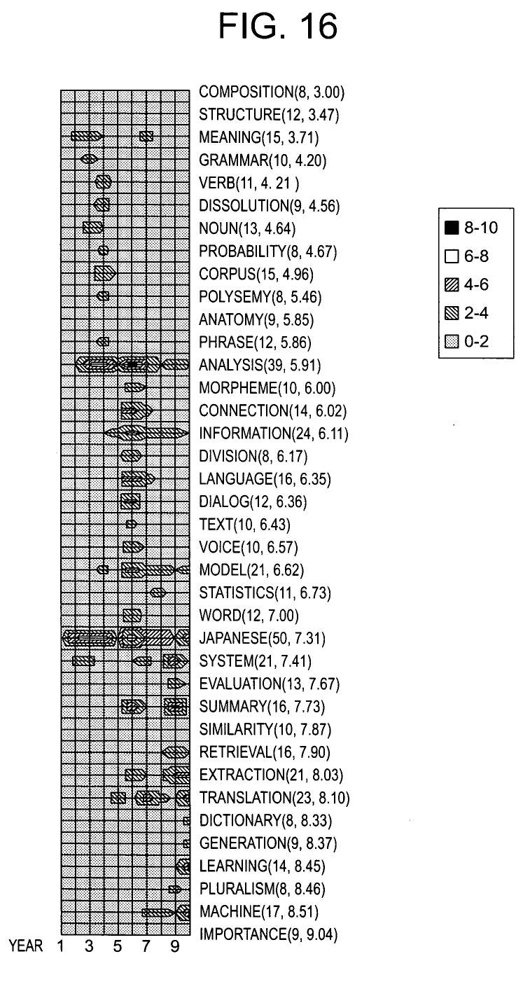

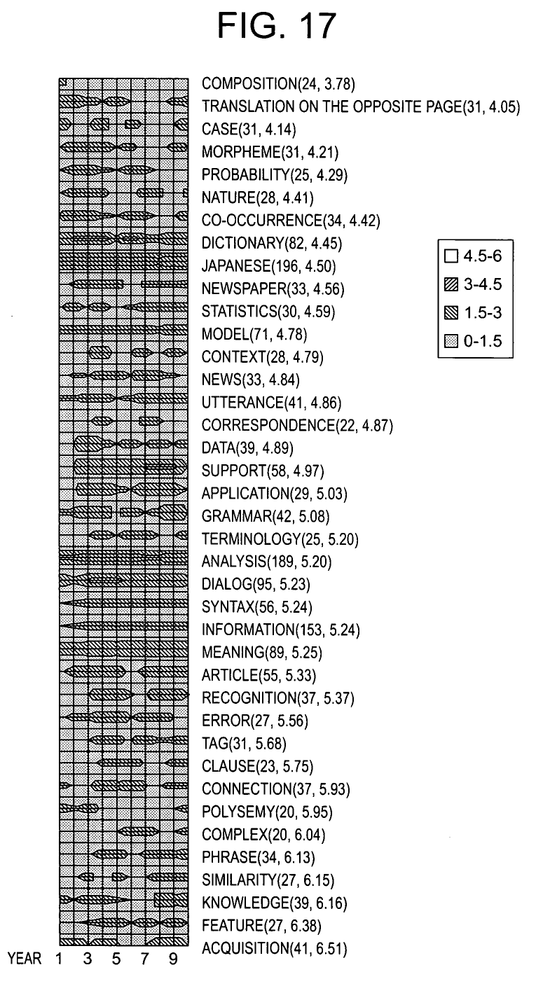

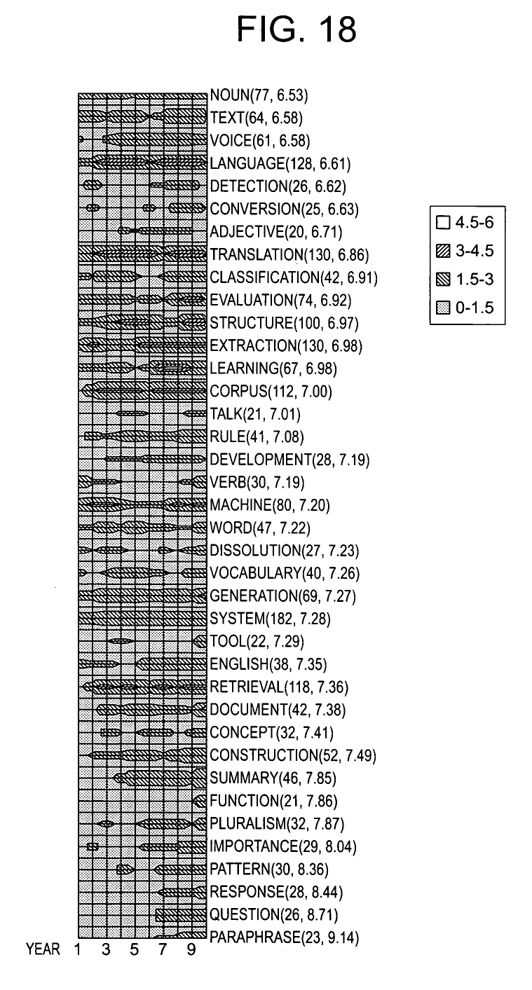

FIG. 16 shows a screen display example of display data for the treatises when the keyword extracted at step S12 is each research field. FIGS. 17 and 18 show the screen display examples for the annual meeting. The height of contour line for display data is the number of cases released in the screen display example of FIG. 16, and logarithm of the number of cases released plus one with a base of 2 in the screen display example of FIGS. 17 and 18.

As shown in FIG. 16, for the treatises, “verb”, “noun”, “dissolution”, “probability”, “corpus”, and “polysemy” are displayed at the upper level, whereby it can be found that the publication for these research fields was active in the earlier years. The publication for “morpheme”, “connection”, “dialog” and “voice” was active in the sixth year, and the publication for “summary”, “retrieval” and “translation” was active in the later years. Particularly, the “summary” appeared partially in the sixth and ninth years because the special issues were published. The “translation” tends to increase, and will increase in the number of cases released in the future.

The publication of “dialog”, “morpheme”, “probability”, “dictionary” and “statistics” in the annual meeting was active in the earlier years, as shown in FIG. 17. Though there are “retrieval”, “summary”, “question” and “paraphrase”, as shown in FIG. 18, it can be easily understood that the publication for these research fields has been recently active. For other research fields, in which year many researches were made can be easily known by referring to FIGS. 16 to 18.

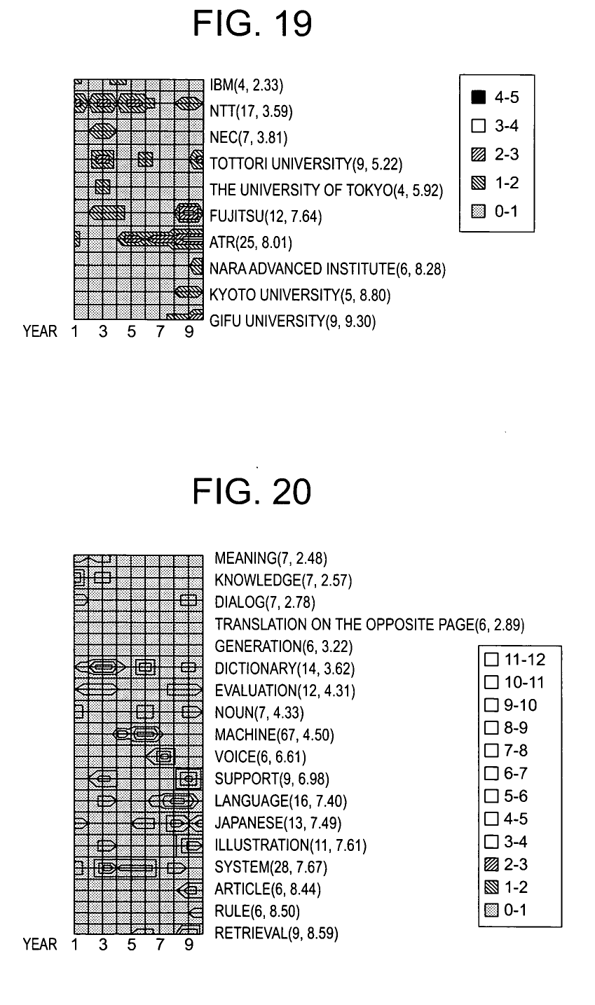

In the embodiment of the invention, the annual publication data may be created, employing the bibliography data containing the predetermined keyword. As an example, the research trend for translation is minutely investigated, and the invention is applied, employing only the data containing the translation as the title of the bibliography data published in the annual meeting. Its results are shown in FIGS. 19 and 20. The height of altitude line in FIGS. 19 and 20 means the number of cases released. As shown in FIG. 19, the research for translation was great in the past in NTT, and is great lately in ATR.

Also seeing FIG. 20, most of the research for translation dealt with “meaning”, “knowledge” and “dictionary” in the past, but lately deals with “support”, “instance”, and “retrieval”.

Moreover, the present invention may be practiced as a program read and executed by a computer. The program implementing the present invention may be stored in an appropriate recording medium such as a portable memory, a semiconductor memory or a hard disk readable by the computer, provided in the recording medium recording the program, or distributed via a communication interface across a network.

What is claimed is:

1. An apparatus for displaying data which displays data corresponding to an ordered item, comprising:
a data input unit inputting the data corresponding to the ordered item related to a description data containing a data item;
a reference value calculation unit calculating, for each of the data item, a reference value that is referenced in sorting the inputted data related to the description data containing each of the data item, based on the inputted data related to the description data containing each of the data item;
a data sort unit sorting the data related to the description data containing each of the data item in the ascending or descending order of the calculated reference values; and
a data display unit creating a display data based on the sorted data and displaying the created display data on a screen.

2. An apparatus for displaying data which displays numerical data corresponding to an ordered item, comprising:
a data input unit inputting the numerical data corresponding to the ordered item related to a description data containing a data item;
a reference value calculation unit calculating, for each of the data item, a reference value that is referenced in sorting the numerical data, based on the input numerical data;
a data sort unit sorting the numerical data related to the description data containing each of the data item in the ascending or descending order of the calculated reference values; and
a data display unit creating a display data based on the sorted numerical data and displaying the created display data on a screen.

3. The apparatus according to claim 1, wherein the reference value calculation unit calculates the reference value, based on the order value of the ordered item.

4. The apparatus according to claim 1, wherein the reference value calculation unit calculates the reference value in which the mean value, the mode value and the median of the order values of the ordered items are averaged.

5. The apparatus according to claim 1, wherein the reference value calculation unit calculates, as the reference value, the mean value of the order values of the ordered items.

6. The apparatus according to claim 1, wherein the reference value calculation unit calculates, as the reference value, the mode value of the order values of the ordered items.

7. The apparatus according to claim 1, wherein the reference value calculation unit calculates, as the reference value, the median of the order values of the ordered items.

8. The apparatus according to claim 1, wherein the data display unit displays the data in which the reference value calculated for each of the data item is plotted as a part of the display data on the screen.

9. The apparatus according to claim 1, wherein the data display unit further displays the display data on the screen in a format where the reference value calculated for each of the data item is written down with the display data.

10. The apparatus according to claim 1,
wherein the data input unit comprises a data accumulation unit accumulating an inputted bibliography data, a data item extraction unit extracting a data item from the accumulated bibliography data, and a data creation unit creating the data corresponding to the ordered item related to the description data containing each of the data item, based on the extracted data item and the bibliography data, and
wherein the reference value calculation unit calculates, for each of the data item, the reference value that is referenced in sorting the data related to the description data containing each of the data item, based on the created data related to the description data containing each of the data item.

11. A method for displaying data which displays data corresponding to an ordered item, comprising:
inputting the data corresponding to the ordered item related to the description data containing a data item;
calculating, for each of the data item, a reference value that is referenced in sorting the inputted data related to the description data containing each of the data item, based on the inputted data related to the description data containing each of the data item;
sorting the data related to the description data containing each of the data item in the ascending or descending order of the calculated reference values;
creating a display data based on the sorted data; and
displaying the created display data on a screen.

12. A program for displaying data which displays data corresponding to an ordered item, the program causing a computer to execute:
inputting the data corresponding to the ordered item related to a description data containing a data item;
calculating, for each of the data item, a reference value that is referenced in sorting the inputted data related to the description data containing each of the data item, based on the inputted data related to the description data containing each of the data item;
sorting the data related to the description data containing each of the data item in the ascending or descending order of the calculated reference values;
creating a display data based on the sorted data; and
displaying the created display data on a screen.
